(19) United States
(12) Patent Application Publication
(10) Pub. No.: US 2002/0078328 A1
(43) Pub. Date: Jun. 20, 2002

(54) Pulse-controlled micropipeline architecture

(75) Inventor: H. Peter Hofstee, Austin, TX (US)

Correspondence Address: FELSMAN, BRADLEY, VADEN,, GUNTER & DILLON, LLP, Suite 350, Lakewood on the Park, 7600B North Capital of Texas Highway, Austin, TX, 78731, US

(73) Assignee: International Business Machines Corporation

(21) Appl. No.: 09/737,637

(22) Filed: Dec. 14, 2000

(51) Int. Cl. G06F 9/00

(52) U.S. Cl. 712/220

(57) ABSTRACT

A control circuit for permitting a two-phase data transfer protocol between stages in a micropipeline. In accordance with the teachings of the present invention, the control circuit includes a control element for generating a data transfer control signal that governs data transport through a level-sensitive latch within the micropipeline. The control circuit further includes a dual-pulse generator receiving the data transfer control signal at its input and providing its output to the control input of the level-sensitive latch. The dual pulse generator converts a rising edge of the data transfer control signal into a first data transfer pulse and a falling edge of the data transfer control signal into a second data transfer pulse such that the micropipeline transfers data during both the rising edge and the falling edge.

### BACKGROUND OF THE INVENTION

1. Technical Field

The present invention relates in general to asynchronous logic circuits, and in particular, to an asynchronous control circuit. More particularly, the present invention relates to a pulse-controlled asynchronous latching control circuit having higher data transfer speed and lower logic gate overhead requirements.

2. Description of the Related Art

Pipelining is commonly utilized for decomposing a data processing operation into multiple concurrently operating stages to increase throughput at the cost of a moderate increase in latency and logic overhead. A wide variety of applications, such as digital signal processors, video processors, and general purpose processors can take advantage of pipeline architecture. Each of these applications may advantageously utilize pipelining to process data in stages where the processing result of one stage is passed to a subsequent stage for further processing. Multiple processing stages are connected together into a series of stages with the stages operating on data as the data passes along from one stage to the next.

There are a variety of distinctions among pipeline processors. One distinction being whether the pipelined stages operate in unison in accordance with an external global clock (a synchronous pipeline), or operate independently based on local events (an asynchronous pipeline).

In synchronous pipelines, synchronization of the different processing stages requires that the frequency of the global control clock accommodate the foreseeable worst-case delay for the slowest processing stage. Thus, in a synchronous pipeline design, some processing stages will complete respective operations earlier than other stages and must then wait for all processing stages to complete their operations. The speed of synchronous processing is directly controlled by the global clock frequency and thus can be increased by increasing the speed of the global clock.

A problem with increasing the synchronous clock frequency is clock skew. A circuit can only operate synchronously if all parts of it receive the clock signal at the same time. However, clock signals are delayed as they propagate through the system and, even on a single chip, clock skew is a problem at higher frequencies.

Asynchronous pipelines avoid worst-case timing and clock skew problems since they include no external clock to govern the timing of state changes among the pipelined stages. Instead, asynchronous stages exchange data at mutually negotiated times with no external timing regulation. More specifically, these mutually negotiated exchanges are locally synchronized using event-driven communication in which logic transitions on control lines act to request the start of a transfer and acknowledge its completion. By removing the global clock, asynchronous pipelines have the advantage of elimination of clock skew problems, freedom from worst-case design restrictions, and automatic power-down of unused circuitry.

A “micropipeline” is a common asynchronous pipeline design invented by Ivan Sutherland as set forth in U.S. Pat. No. 4,837,740 and U.S. Pat. No. 5,187,800, the pertinent portions of which are incorporated herein by reference. The approach in Sutherland's micropipeline utilizes bundled data with a transition-signaled handshake protocol to control data transfers. A block diagram of a sender/receiver interface within a conventional micropipeline is illustrated in FIG. 1.

Two stages of a micropipeline 100 are depicted in FIG. 1, including a sender stage 102 that delivers data in accordance with the micropipeline handshake protocol to a receiver stage 104. As depicted in FIG. 1, the interface between sender stage 102 and receiver stage 104 includes a data path 106. A request line 110 and acknowledge line 108 are delivered over control paths.

A request signal from sender 102 to receiver 104 is delivered by a logic transition on line 110 when data at the output of sender 102 is valid (ready to be delivered to receiver stage 104). An acknowledge signal from receiver 104 to sender 102 is delivered by a logic transition on acknowledge line 108 when the data has been processed by receiver 104. This data transfer control protocol results in no upper bound delay between consecutive events. As long as the data bundling constraints are met (i.e., the data transfer occurs in accordance with the handshake protocol described above), micropipeline 100 is delay-insensitive.

There are two alternative signaling protocols available for handshaking utilizing request line 110 and acknowledge line 108; namely a two-phase protocol and a four-phase protocol. The behavior of request line 110 and acknowledge line 108 for a four-phase micropipeline control protocol is depicted in FIG. 2A.

The four-phase protocol is a return to zero protocol. FIG. 2A illustrates the relative behavior of a request signal, req1, an acknowledge signal, ack1, and a corresponding data signal, data1, during a single four-phase data transfer cycle. The rising edge of req1 signals the validity of data within sender 102 and the readiness of sender 102 to send the data. The rising edge of ack1 indicates that the data has been received and processed by receiver 104. It should be noted that the falling edges of req1 and ack1 comprise the recovery phase of the four-phase protocol during which no data transfer occurs. A widely recognized advantage of implementing a four-phase micropipeline handshake protocol is that four-phase macromodule components are relatively simple and provide optimum latch control.

A two-phase micropipeline handshake protocol is depicted in FIG. 4B. The rising edges of a request signal, req, and an acknowledge signal, ack, signal the start and end of validity for a data signal, data, as for the four-phase protocol. As seen in FIG. 4B, however, a two-phase protocol does not have a return to zero phase. Instead, the handshake finishes with req and ack at a logic high. The subsequent falling edges of req and ack initiate the next handshake for the next set of valid data.

Whereas a four-phase protocol provides superior latch control, a two-phase protocol yields a higher transfer frequency. Other potential advantages of two-phase signaling includes that fact that fewer signal transitions are required which reduces power consumption and that the lack of a recovery phase provides for faster data transfer across multiple stages. The control circuits utilized in standard micropipelines provide control signals for level-sensitive latches within the micropipeline data path. Such level-sensitive latches require two clock elements, such as two half latches, to create a complete latching stage (i.e., a stage that can hold and propagate information). To implement two-phase signaling within half latches, two-to-four phase converters are required on each latch controller which greatly increases hardware overhead and control signaling complexity. Another approach is to replace level-sensitive latches with more complex dual-edge triggered flip-flops.

Current micropipeline design must therefore decide between the simpler design and reduced hardware overhead of a four-phase architecture or the faster but more complex two-phase control architecture.

From the foregoing, it can be appreciated that a need exists within a micropipeline architecture for an interface between control elements and data path latches that would permit two-phase signaling with minimal hardware overhead.

### SUMMARY OF THE INVENTION

A control circuit for permitting a two-phase data transfer protocol between stages in a micropipeline is disclosed herein. In accordance with the teachings of the present invention, the control circuit includes a control element for generating a data transfer control signal that governs data transport through a level-sensitive latch within the micropipeline. The control circuit further includes a dual-pulse generator receiving the data transfer control signal at its input and providing its output to the control input of the level-sensitive latch. The dual pulse generator converts a rising edge of the data transfer control signal into a first data transfer pulse and a falling edge of the data transfer control signal into a second data transfer pulse such that the micropipeline transfers data during both the rising edge and the falling edge.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting an inter-stage data and control interface in a conventional micropipeline;

FIG. 2 illustrates a conventional micropipeline in which level-sensitive latches are utilized for implementing a four-phase data transfer handshake protocol;

FIG. 3 is a transistor-level illustration of a micropipeline control element applicable within the micropipeline control circuit of the present invention;

FIG. 4A is a signal diagram illustrating a four-phase micropipeline handshake protocol;

FIG. 4B is a signal diagram depicting a two-phase micropipeline handshake protocol;

FIG. 5 depicts a micropipeline incorporating a dual pulse control signal interface in accordance with a preferred embodiment of the present invention;

FIG. 6 is a gate level depiction of a dual pulse generator applicable to the micropipeline in FIG. 5 in accordance with one embodiment of the present invention; and

FIG. 7 is a timing diagram illustrating a dual pulse data transfer handshake protocol for the micropipeline in FIG. 5.

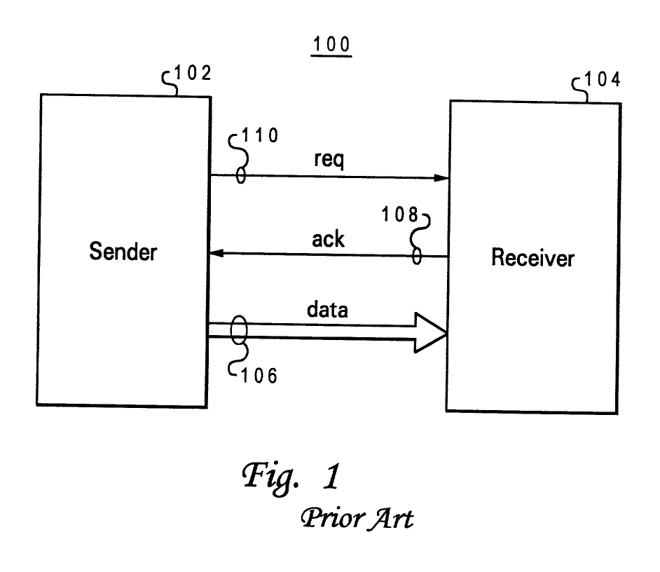

### DETAILED DESCRIPTION OF THE PREFERRED EMBODIMENT

This invention is described in a preferred embodiment in the following description with reference to the figures. While this invention is described in terms of the best mode for achieving this invention's objectives, it will be appreciated by those skilled in the art that variations may be accomplished in view of these teachings without deviating from the spirit or scope of the present invention.

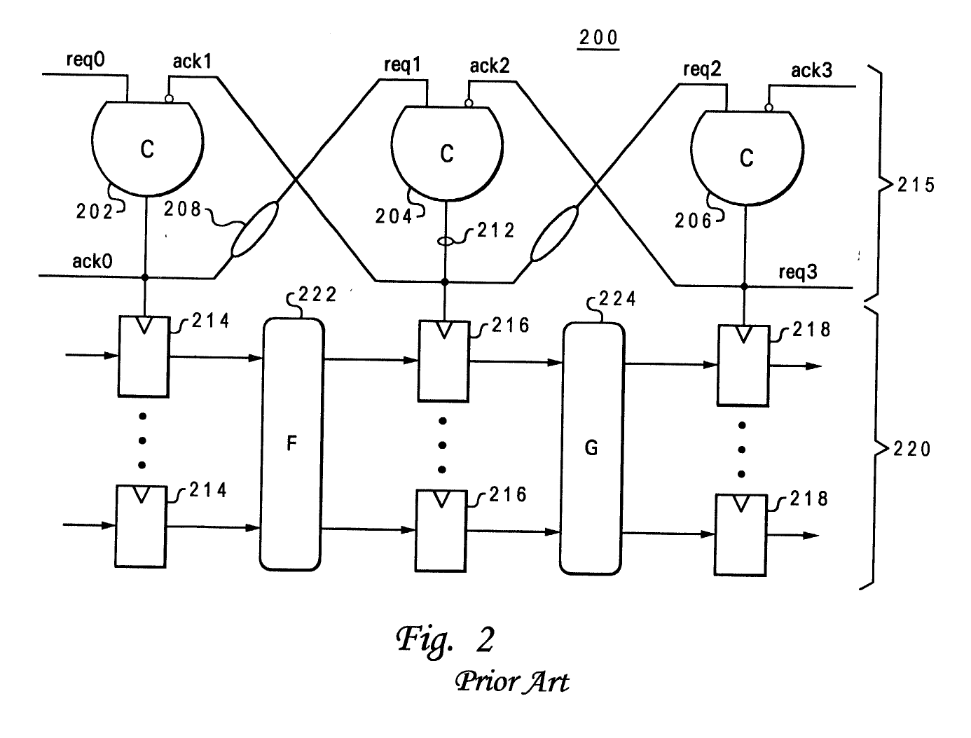

With reference now to the figures wherein like reference numerals refer to like and corresponding parts throughout, and in particular with reference to FIG. 2, there is illustrated a conventional micropipeline 200 in which level-sensitive latches are utilized for implementing a four-phase data transfer handshake protocol. A data path 220 within micropipeline 200 includes data processing stages 222 and 224 wherein data is processed in accordance with within combinatorial logic functions F and G.

In accordance with conventional micropipeline design, data path 220 further includes a series of level-sensitive half-latches 214, 216, and 218 that serve to hold and propagate data between processing stages 222 and 224 as well as previous and subsequent processing stages not depicted. A wide variety of latch designs are available for latches 214, 216 and 218 including, for example, level-sensitive D-latches. In accordance with well known level-sensitive half-latch operating principles, a particular control signal polarity (high or low) will cause such latches to open and thus become transparent to data at their inputs. The sequence and timing of the latching stages must be carefully set to prevent data collisions among the respective data processing stages. In the depicted example, it is assumed that latches 214, 216, and 218 are opened upon receiving a high control signal.

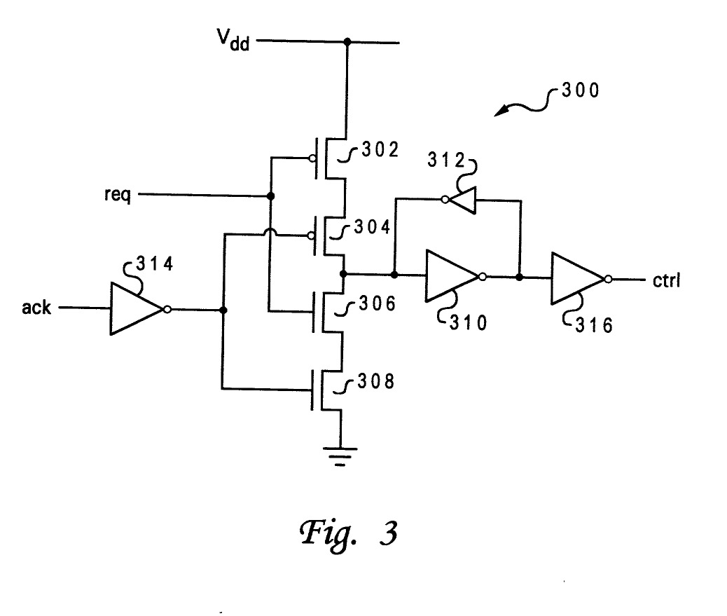

Micropipeline 200 further includes a control path 215 comprising multiple control elements for providing sequential data transfer control between data processing stages 222 and 224. Specifically three Muller C-elements 202, 204, and 206 are utilized to implement such micropipeline control. FIG. 3 is a transistor-level illustration of a an exemplary micropipeline control element applicable within micropipeline 200.

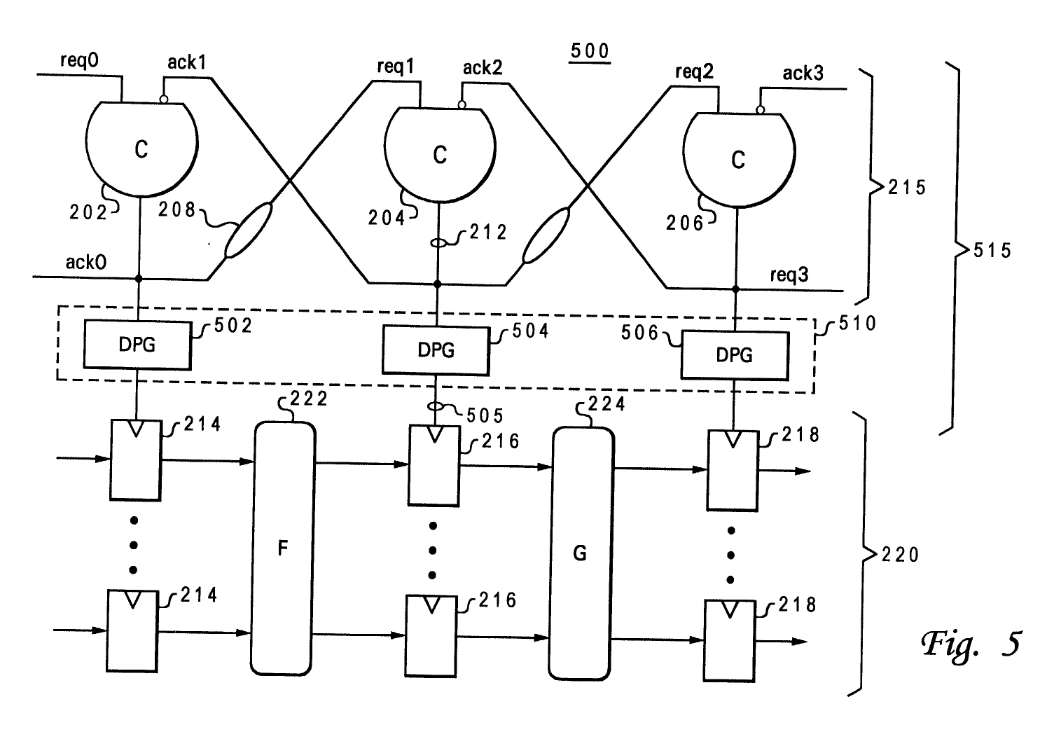

Referring to FIG. 3, a Muller C-element 300 is depicted as producing a control (ctrl) output from a request (req) input and an acknowledge (ack) input. Muller C-element 300 includes a pull-up net comprising a pair of PFET's 302 and 304 and a pull-down net comprising a pair of NFET's 306 and 308. In accordance with the gate-level C-element representations in FIG. 2 (as well as in the preferred embodiment depicted in FIG. 5) the ack input is inverted by an input inverter 314. A double inversion net, comprising a pair of inverters 310 and 316, sets and maintains the ctrl output with the aid of a weak feedback inverter 312. Muller C-element 300 generates the ctrl output signal as follows.

When the ack signal is a logic high and the req signal is a logic low, the pull-down net switches on and the ctrl output is set to a logic low. If subsequently the ack signal switches to a logic low while the req signal remains at a logic low, the pull-down net is switched off while the pull-up net remains off, resulting in the ctrl output being held by weak feedback inverter 312 at a logic low. Similarly, if after the ctrl output is set low, the req signal switches to a logic high while the ack signal remains at a logic high, the pull-down net is switched off while the pull-up net remains off, resulting in the ctrl output remaining low.

When the ack signal is a logic low and the req signal is a logic high, the pull-up net switches on and the ctrl output is set to a logic high. If subsequently the ack signal switches to a logic high while the req signal remains at a logic high, the pull-up net is switched off while the pull-down net remains off, resulting in the ctrl output being held by weak feedback inverter 312 at a logic high. Similarly, if after the ctrl output is set high, the req signal switches to a logic low while the ack signal remains at a logic low, the pull-up net is switched off while the pull-down net remains off, resulting in the ctrl output remaining high.

The operation of a Muller C-element as described above is commonly understood by those skilled in the asynchronous pipeline field of art. A detailed description of C-elements is provided in by Sutherland in Micropipelines, 32 Communications of ACM 720 (1989), the subject matter of which is incorporated herein by reference. Alternative logic configurations for constructing a C-element such as those depicted in U.S. Pat. No. 5,732,233 (1998) are well-known in the art and are incorporated herein by reference.

Referring back to FIG. 2, and in accordance with the foregoing description of control element operating principles, the control output of any of C-elements 202, 204, or 206 changes state, regardless of its previous state, only after both of its req and ack inputs have changed state. Otherwise each C-element retains its current state. Thereafter, if either one of req or ack changes states, the output remains unchanged from the immediately preceding state. When both req and ack have changed from high to low, or from low to high, the output also changes from high to low, or from low to high, as the case may be.

The req and ack lines depicted in FIG. 2 form an inter-stage handshake interface between C-elements 202, 204, and 206. Each of the req signals that are applied as inputs to each C-element, originate as output data transfer control signals from a previous stage. Each C-element also receives an ack input that is delivered from the output of the immediately subsequent C-element.

In addition to serving as handshake control signals req and ack, the outputs from each of C-elements 202, 204, and 206 are utilized as control inputs for level-sensitive latches 214, 216, and 218, respectively. Assuming positive level activation for the latches, a logic high produced as the latch control signal from a C-element results in opening the corresponding latch.

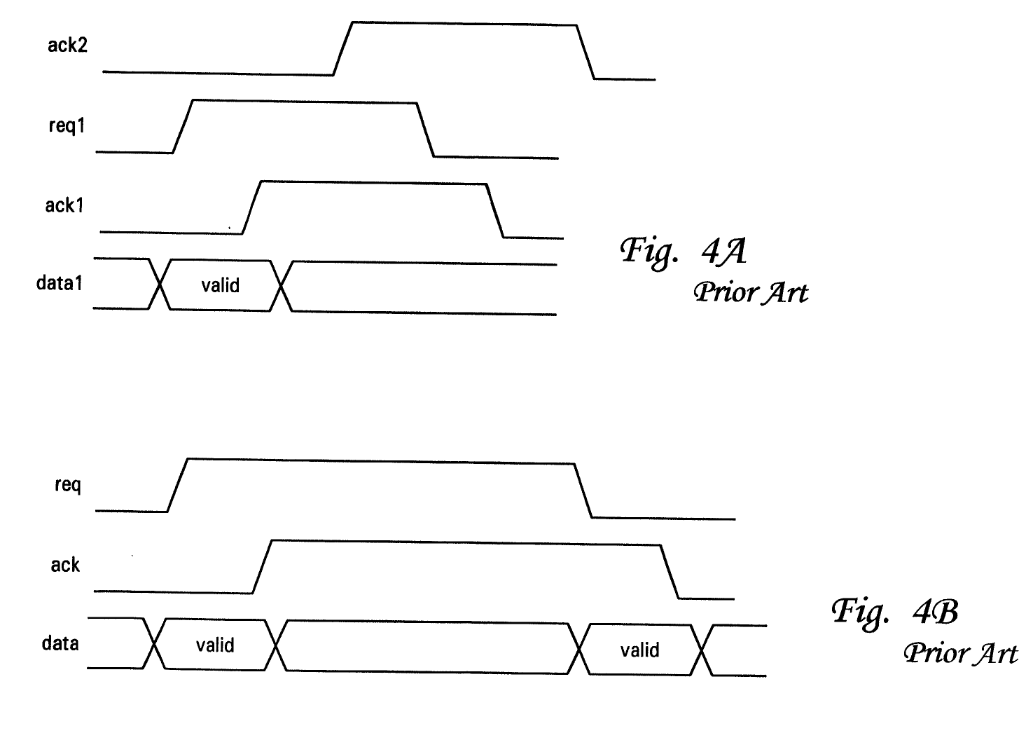

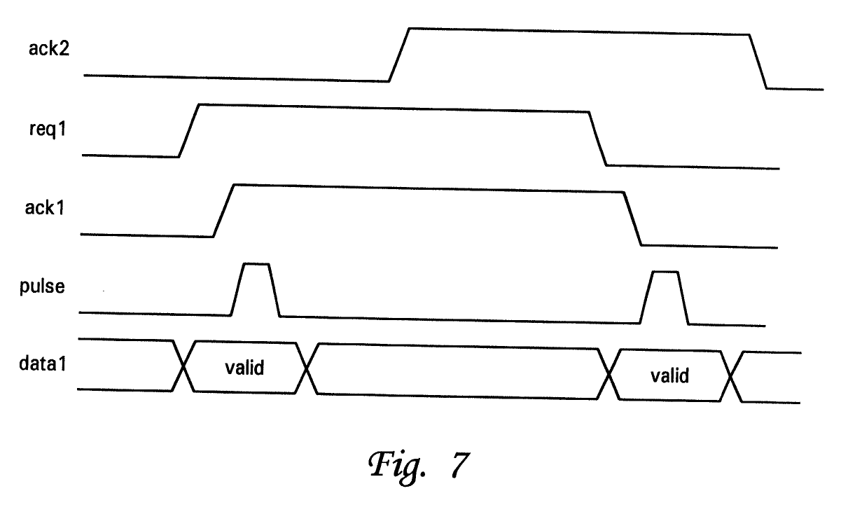

Referring to FIG. 4A in conjunction with FIG. 2, a four-phase data transfer operation for delivering data from data processing stage 222 to data processing stage 224 through latches 216 is illustrated. FIG. 4A depicts the relative behavior of req1 and ack1 at the inputs of C-elements 204 and 202 respectively, and a corresponding data signal, data1, during a single four-phase data transfer cycle. It should be noted that for minimum data transfer latency, a conventional micropipeline such as micropipeline 200 is typically initialized with all data latches open. However, the two-phase data transfer protocol of the present invention (as described with reference to FIGS. 5 and 7) is not operable if the data transfer latches are open in the initialized and empty states. Therefore, to provide a consistent base of reference, an analogous “initially closed” latch state for micropipeline 200 is described herein.

To pass data1 through latches 214 into processing stage 222, C-element 202 asserts a data transfer control signal at its output. This asserted data transfer control signal propagates through a delay device 208 to assert req1 at the input of C-element 204. Delay device 208 is included within the control line connecting the output of C-element 202 to the input of C-element 204 to delay the assertion of req1 with respect to the activation signal applied by C-element 202 to latches 214 to ensure that data1 is valid at the input of latches 216 prior to C-element opening latches 216.

The data transfer request from C-element 202 to C-element 204 is illustrated by the rising edge of req1 in FIG. 4A. Upon receipt of req1, and assuming that ack2 is low, C-element 204, having received two logic highs at its inputs, produces a logic high at its output 212 thus opening level-sensitive latches 216 and allowing data1 to pass through to processing stage 224.

The asserted data transfer control signal at output 212 asserts ack1 at the input of C-element 202. The rising edge of ack1 indicates that the data has been received and processed by processing stage 224. In accordance with the foregoing description of C-element behavior, the assertion of ack1 together with the de-assertion (high-to-low) of the req0 input to C-element 202 results in the data transfer control signal at the output of C-element 202 being de-asserted and latches 214 being closed. The de-asserted transfer control signal at the output of C-element 202 is delayed through delay device 208 before de-asserting req1 at the input of C-element 204.

The de-assertion of the request signal into C-element 204 is illustrated in FIG. 4A as the falling edge of req1. The acknowledge input to C-element 204, ack2, has been asserted in sequence in the same manner as that described for ack1 by the time req1 has been de-asserted. Upon de-assertion of req1 and assertion of ack2, data transfer control output 212 is de-asserted, resulting in the de-assertion of ack1 as depicted by the falling edge of ack1 in FIG. 4A. The falling edges of req1 and ack1 at the inputs of C-elements 204 and 202, respectively, comprise the recovery phase of the four-phase protocol during which no data transfer occurs across processing stages 222 and 224.

It is upon the four-phase protocol micropipeline 200 of FIG. 2 that the pulse-controlled design of the present invention improves. Referring now to FIG. 5, there is depicted a micropipeline 500 incorporating a dual pulse control circuit in accordance with a preferred embodiment of the present invention. As with micropipeline 200 in FIG. 2, micropipeline 500 includes data path 220 wherein data processing stages 222 and 224 process data in accordance with within combinatorial logic functions F and G.

Within data path 220, half-latches 214, 216, and 218 hold and propagate data between processing stages 222 and 224 as well as previous and subsequent processing stages not depicted. Assuming positive level activation for the latches, a logic high applied to the control input of any of half-latches 214, 216, or 218 results in the corresponding latch opening.

The sequence and timing of the latching stages must be carefully set to prevent data collisions among the respective data processing stages. For the conventional micropipeline depicted in FIG. 2, data collisions are avoided by implementing the four-phase data transfer protocol illustrated in FIG. 4A whereby successive latching stages are opened and closed by the control outputs of the C-elements in accordance with the req and ack handshake signals. As explained in further detail hereinbelow, micropipeline 500 provides data isolation and validity assurances by incorporating a pulse-controlled data latching technique.

Control path 215 includes C-elements 202, 204, and 206 for providing sequential data transfer control between data processing stages 222 and 224. Request and acknowledge lines form an inter-stage handshake interface among C-elements 202, 204, and 206.

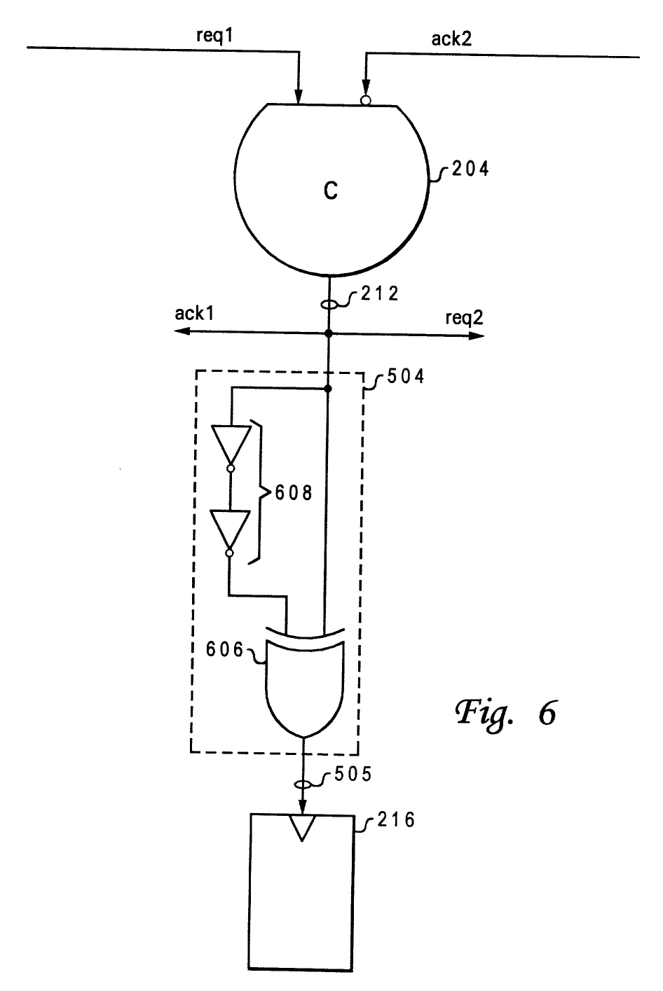

In accordance with the teachings of the present invention, micropipeline 500 includes a control circuit 515 that includes a series of dual pulse generators 502, 504, and 506, coupled to control path 215. Specifically, dual pulse generators 502, 504, and 506 serve as a pulse-control interface 510 between C-elements 202, 204, and 206, and half-latches 214, 216, and 218. Each of dual pulse generators 502, 504, and 506 translates the level-sensitive control signaling provided at the outputs of C-elements 202, 204, and 206 into a dual pulse data transfer control signal that enables each of half-latches 214, 216, and 218 to open and close (propagate and hold) during each edge transition of a data transfer control signal at the outputs of the C-elements. FIG. 6 is a gate-level representation of a dual pulse generator applicable to the embodiment depicted in FIG. 5.

Referring to FIG. 6, dual pulse generator 504 includes a two-input exclusive-OR (XOR) logic gate 606 receiving a data transfer control signal directly from C-element 204 at one input and a delayed data transfer control signal at the other input. The delay on the data transfer control signal is imparted by a pair of inverters 608. Dual pulse generator 604 produces a pulse at output node 505 on both a rising edge and a falling edge of the data transfer control signal from C-element 204. It should be noted that a wide variety of circuit configurations are available for generating a pulse on both a rising and a falling edge input, and that the dual pulse generator incorporated within the present invention is not limited to the particular implementation depicted in FIG. 6.

Referring back to FIG. 5, each of dual pulse generators 502, 504, and 506 receive as inputs, the outputs of the C-elements 202, 204, and 206, respectively. Referring to FIG. 7 in conjunction with FIG. 5, a two-phase data transfer operation for delivering data from data processing stage 222 to data processing stage 224 through latches 216 is illustrated.

FIG. 7 depicts the relative behavior of req1 and ack1, and corresponding data signal, data1, during two 2-phase data transfer cycles.

To pass data1 through latches 214 into processing stage 222 from the processing stage preceding stage 222, C-element 202 asserts (low-to-high) a data transfer control signal at its output. This asserted data transfer control signal propagates through delay device 208 to assert req1 at the input of C-element 204.

The data transfer request from C-element 202 to C-element 204 is illustrated by the rising edge of req1 in FIG. 7. Upon receipt of req1, and assuming that ack2 is low, C-element 204, having received two logic highs at its inputs, asserts a logic high at its output 212. This low-to-high transition at output 212 is depicted in FIG. 7 as the rising edge of ack1 which coincides with the data transfer control signal at node 212.

Upon receipt of the rising edge of ctrl, dual pulse generator 504 produces a pulse on output node 505, depicted as pulse in FIG. 7. The duration of this pulse is set in accordance with the delay design of dual pulse generator 504. For the dual pulse generator design depicted in FIG. 6, the delay can be set by selecting the number of pairs of inverters in accordance with the desired pulse width. The temporary assertion of pulse during data1 valid results in level-sensitive latches 216 being briefly opened and then closed as pulse returns to a logic low thus allowing data1 to pass through to processing stage 224.

The rising edge of ack1 at the input of C-element 202 indicates that the data has been received and processed by processing stage 224. The assertion of ack1 together with the de-assertion (high-to-low) of the req0 input to C-element 202 results in the data transfer control signal at the output of C-element 202 being de-asserted. It should be noted that latches 214, being controlled in the same manner as that described for latches 216, are opened briefly during this high-to-low transition at the output of C-element 202 and will thus permit data to pass from the preceding data processing stage to data processing stage 222.

The de-asserted data transfer control signal at the output of C-element 202 is delayed through delay device 208 before de-asserting req1 at the input of C-element 204. Prior to the de-assertion of req1, the ack2 input into C-element 204 has been asserted, resulting in a high-to-low transition of ack1 at node 212. In response to the falling edge of ack1, dual pulse generator 504 generates another pulse on output node 505 as depicted in FIG. 7 such that there is no recovery phase during a control signal transition.

While the invention has been particularly shown and described with reference to a preferred embodiment, it will be understood by those skilled in the art that various changes in form and detail may be made therein without departing from the spirit and scope of the invention.

What is claimed is:

1. A two-phase data transfer protocol circuit for a micropipeline, said circuit comprising:
a control element for generating micropipeline data transfer control signals according to a multiple phase protocol; and
a pulse generator connected to said micropipeline and operable to produce pulse signals responsive to both rising and falling edges of said data transfer control signals.

2. The circuit of claim 1, further comprising a level-sensitive latch for holding and propagating data through said micropipeline.

3. The circuit of claim 2, wherein said pulse generator is a dual-pulse generator that delivers a data transfer pulse to said level-sensitive latch in response to both said rising edge and said falling edge of said data transfer control signals.

4. The circuit of claim 1, wherein said control element is a Muller C-element.

5. The circuit of claim 1, wherein said pulse generator comprises:
a logic gate having a first input and a second input, wherein said first input is connected to the output of said control element; and
a delay element connected between the output of said control element and said second input, wherein a pulse is produced at the output of said logic gate in accordance with the delay imparted on said data transfer control signal by said delay element.

6. The circuit of claim 5, wherein said logic gate is a XOR gate.

7. The circuit of claim 5, wherein said delay element comprises an even number of inverters.

8. A micropipeline comprising:
a plurality of C-elements for providing sequential data transfer control among a plurality of data processing stages within said micropipeline;
a plurality of latches for holding and propagating data through said plurality of processing stages; and
a plurality of dual-pulse generators for translating signal transitions from the outputs of said C-elements into latch control pulses for said plurality of latches.

9. A method for implementing a two-phase data transfer protocol between stages in a micropipeline, said method comprising:
generating a data transfer control signal for transferring data to a next micropipeline stage; and
converting both a rising edge and a falling edge of said data transfer control signal into a pulse signal such that said micropipeline transfers data during both said rising edge and said falling edge.

10. The method of claim 9, further comprising holding and propagating data through said micropipeline utilizing a level-sensitive latch.

11. The method of claim 10, wherein said micropipeline includes a Muller C-element for generating said data transfer control signal, and wherein said converting a rising edge and a falling edge of said data transfer control signal into pulse signals is performed utilizing a dual pulse generator, said method further comprising:
applying said data transfer control signal from said Muller C-element to the input of said dual pulse generator; and
delivering said data transfer pulses from said dual pulse generator to said level-sensitive latch in response to a rising edge and a falling edge of said data transfer control signal.
